(19) United States
(12) Patent Application Publication
(10) Pub. No.: US 2017/0328347 A1
(43) Pub. Date: Nov. 16, 2017

(54) APPARATUS FOR AMPLIFYING ROTATING FORCE OF WIND POWER GENERATOR

(71) Applicant: Choo Won LEE, Gyeonggi-do (KR)

(72) Inventor: Ha Jin LEE, Gyeonggi-do (KR)

(21) Appl. No.: 15/372,655

(22) Filed: Dec. 8, 2016

(30) Foreign Application Priority Data
May 12, 2016 (KR) 10-2016-0058098

(51) Int. Cl. F03D 15/10; F03D 3/00; F16H 1/14; F16H 37/02; F16H 7/02

(52) U.S. Cl. CPC F03D 15/10; F03D 3/005; F16H 7/02; F05B 2260/403; F05B 2260/4021; F16H 37/02; F16H 1/14

(57) ABSTRACT

An apparatus for amplifying rotating force of a wind power generator includes a blade rotated by wind power, a central rotating shaft rotated by the rotation of the blade, upper and lower horizontal rotating units spread upwards or downwards when the blade rotates, upper and lower fastening plates, a vertical rotating unit continuously rotating the upper horizontal rotating unit and doubling the rotating speed of the upper horizontal rotating unit by repulsive force of a magnetic member, a horizontal rotating shaft rotating the vertical rotating unit as the blade rotates, a shaft conversion unit rotating the horizontal rotating shaft by the rotation of the central rotating shaft, a horizontal-rotating-shaft support supporting the vertical rotating unit and the horizontal rotating shaft, a frame unit stably holding the apparatus and protecting the apparatus from external force, and a bearing.

### CROSS REFERENCE

This application claims priority of Korean Patent Application No. 10-2016-0058098, filed on May 12, 2016, in the Korean Intellectual Property Office, which is hereby incorporated by reference in its entirety.

### BACKGROUND

The present invention relates to an apparatus for amplifying rotating force of a wind power generator, and more particularly, to an apparatus for amplifying rotating force of a wind power generator, which doubles the rotating speed of a blade by ascending air current and rotational inertia, thus enhancing power generating efficiency and simultaneously facilitating the continuous rotation of the blade even when the blade rotates at low speed due to a lack of wind power.

In general, a typical power generating method for producing electricity may include thermal power generation in which mechanical energy generated by the combustion of fossil fuel is converted into electric energy, thus producing electric power, and nuclear power generation in which water is heated using energy generated by fission chain reaction to produce vapor and then a turbine of a generator is rotated by the vapor, thus producing electric power. However, such a power generating method is problematic in that huge construction cost is required to build power generating facilities, a quantity of harmful substances, such as radiation, radioactive waste or exhaust gas that are harmful for environment and human bodies in a power generating process, may be discharged, and serious environmental destruction may be caused when an accident occurs in power generating facilities. Thus, research into the power generating method of utilizing natural energy, such as wind power, tidal power, water power or solar heat, as an energy source is actively conducted, because the natural energy does not cause pollution unlike thermal power- or nuclear power-generation and there is no possibility that the natural energy is depleted. Here, wind power generation in which wind power energy is converted into electric energy using a blade that may be rotated by wind, thus producing electric power is simple in structure or installation of power generating facilities and is easy to operate and manage the power generating facilities due to unmanned or automatic operation. For this reason, recently, the adoption of the wind power generation is rapidly increased.

For example, a wind power generator has been proposed in Korean Appl. No. 10-2008-0083107. According to the cited document, a blade rotated by wind power is fastened via a spoke to an outer surface of a rotor that is inserted into a rotating shaft. Thus, even when the blade is rotated at low speed because the wind power acting on the blade is insufficient, the wind power generator may generate electromotive force by electromagnetic induction action between the rotor and a stator.

However, the above-described invention is configured such that the rotor and the stator that may generate electromotive force by electromagnetic induction action between them are opened to an outside. Thus, this is problematic in that power generating equipment may be damaged by external force acting on the power generating equipment or by water that may penetrate into the power generating equipment in the case of rain during a power generating process, and it is impossible to produce electricity of constant output when uniform wind power does not act on the blade fastened to the outer surface of the rotor, so that the wind power should be converted into constant output using a separate electric power converter.

In order to solve the problems, the present invention is intended to provide an apparatus for amplifying rotating force of a wind power generator, in which an upper horizontal rotating unit and a lower horizontal rotating unit that are inserted into the same rotating shaft as a blade rotatable by wind power and are provided under the blade are rotated by the rotation of the blade, so that the rotating speed of the blade is increased by ascending air current produced in the upper horizontal rotating unit and rotational inertia increased by the lower horizontal rotating unit, thus allowing the wind power generator to efficiently generate power, and magnetic members are inserted into ends of the upper horizontal rotating unit and a vertical rotating unit that is rotatable by the rotation of the upper horizontal rotating unit such that the same poles are opposite to each other, so that the blade is continuously rotated by repulsive force between the magnetic members even when the blade rotates at low speed due to a lack of wind power acting on the blade, thus facilitating continuous power generation, and simultaneously the rotating speed of the blade may be doubled when the blade rotates at high speed.

### SUMMARY OF THE INVENTION

Accordingly, the present invention has been made keeping in mind the above problems occurring in the related art, and an aspect of the present invention is directed to an apparatus for amplifying rotating force of a wind power generator, in which an upper horizontal rotating unit capable of generating ascending air current as the upper horizontal rotating unit is rotated by the rotation of a blade by wind power and a lower horizontal rotating unit capable of increasing rotational inertia may be inserted into the same rotating shaft as the blade, the blade may be continuously rotated even when the blade rotates at low speed due to a lack of wind power acting on the blade, and simultaneously the rotating speed of the blade may be doubled when the blade rotates at high speed.

In order to accomplish the object, the present invention provides an apparatus for amplifying rotating force of a wind power generator, including a central rotating shaft provided to pass through a multilayered rack-like frame unit to be rotated by wind power; a blade coupled to an uppermost end of the central rotating shaft; and upper and lower horizontal rotating units fastened to upper and lower fastening plates that are installed about the central rotating shaft to produce ascending air current or increase rotational inertia, by spreading the horizontal rotating units upwards or downwards when the blade is rotated.

Further, the present invention provides an apparatus for amplifying rotating force of a wind power generator, including a vertical rotating unit rotated vertically in conjunction with a central rotating shaft so as to increase rotating force of an upper horizontal rotating unit; a vertical rotating unit coupled via a horizontal rotating shaft to continuously rotate the upper horizontal rotating unit by repulsive force between magnetic members fastened to a side of a vertical wing of the vertical rotating unit and simultaneously double rotating speed of the upper horizontal rotating unit; and a bearing provided to smoothly rotate the central rotating shaft and the horizontal rotating shaft by wind power acting on the blade.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIGS. 1 and 2 are views illustrating an apparatus for amplifying rotating force of a wind power generator;

FIGS. 3 and 4 are exploded perspective views illustrating the apparatus for amplifying the rotating force of the wind power generator;

FIGS. 5A and 5B are a view and a detailed view illustrating a horizontal rotating shaft and a shaft conversion unit of the apparatus for amplifying the rotating force of the wind power generator;

FIG. 6 is an exploded perspective view illustrating an upper horizontal rotating unit of the apparatus for amplifying the rotating force of the wind power generator;

FIG. 7 is an exploded perspective view illustrating a vertical rotating unit of the apparatus for amplifying the rotating force of the wind power generator;

FIGS. 8A and 8B are views illustrating upper and lower horizontal rotating units of the apparatus for amplifying the rotating force of the wind power generator, when they are closed and opened;

FIG. 9 is a view illustrating the vertical rotating unit of the apparatus for amplifying the rotating force of the wind power generator, when the vertical rotating unit is closed; and

FIGS. 10 and 11 are a view and a detailed view illustrating the apparatus for amplifying the rotating force of the wind power generator.

### DETAILED DESCRIPTION OF THE INVENTION

Exemplary embodiments of the present invention will be described below in detail with reference to the accompanying drawings.

Unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

While the invention will be described in conjunction with exemplary embodiments, it will be understood that the present disclosure is not intended to limit the invention to those exemplary embodiments. On the contrary, the invention is intended to cover not only the exemplary embodiments, but also various alternatives, modification, and equivalents thereof.

According to the present invention, an apparatus for amplifying rotating force of a wind power generator includes a multilayered rack-like frame unit 1100 having layered horizontal frames 1110, vertical frames 1120 provided between the horizontal frames to define space, and a side frame 1130 provided on a side of each horizontal frame.

A central rotating shaft 200 is rotatably provided to pass through the multilayered rack-like horizontal frames of the frame unit.

A blade 100 is coupled to an uppermost end of the central rotating shaft to cause the central rotating shaft to be rotated by wind power.

An upper fastening plate 400 is provided on an upper surface of an uppermost horizontal frame of the frame unit around the central rotating shaft.

A lower fastening plate 600 is provided on a lower surface of an associated horizontal frame of the frame unit around the central rotating shaft.

At least one upper horizontal rotating unit 300 is coupled to the upper fastening plate 400 installed under the blade 100 around the central rotating shaft, and is opened downwards by centrifugal force, when the central rotating shaft is rotated by the blade.

At least one lower horizontal rotating unit 500 is coupled to the lower fastening plate 600 to be opened upwards by centrifugal force, when the central rotating shaft is rotated.

A vertical rotating unit 700 includes a horizontal rotating shaft 800 that is coupled to pass through a horizontal-rotating-shaft support 1000 mounted on an upper surface of the side frame to be vertically rotated in conjunction with the central rotating shaft and thereby increase rotating force of the upper horizontal rotating unit, and a vertical rotating wing 720 provided on a central rotating part 710 that is coupled to the horizontal rotating shaft via a horizontal-rotating-shaft passing hole 711.

Further, a shaft conversion unit 900 is provided to convert a horizontal rotating motion of the central rotating shaft into a vertical rotating motion using the rotating force of the central rotating shaft so as to rotate the vertical rotating unit 700.

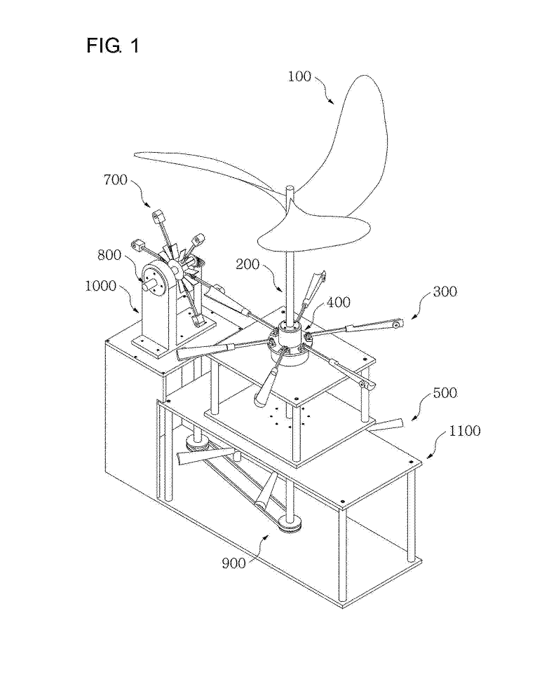

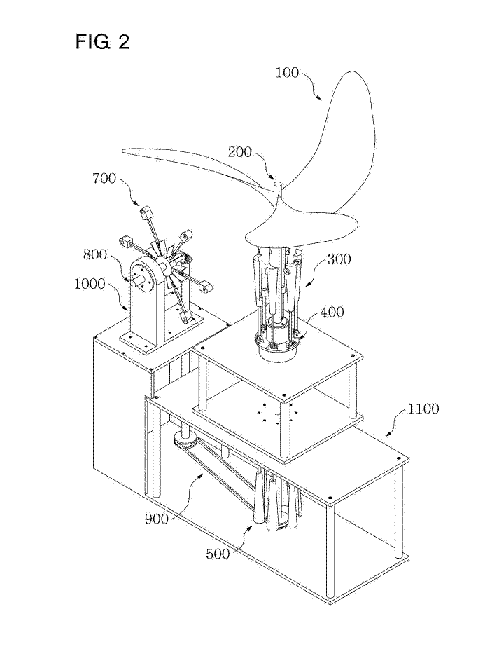

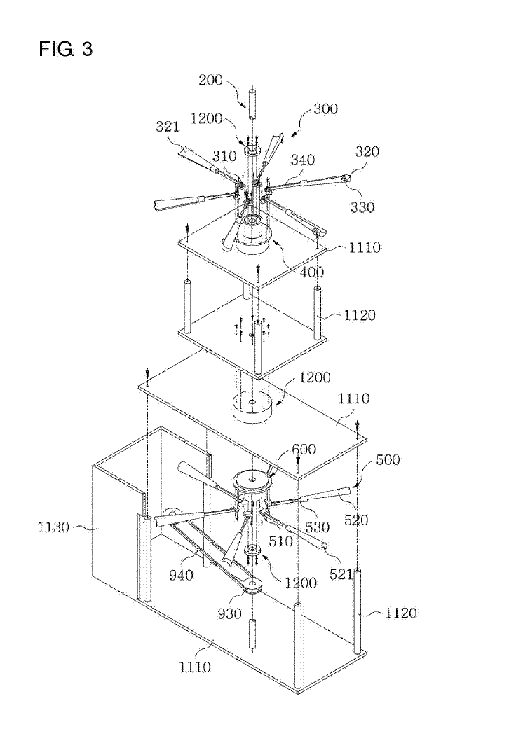

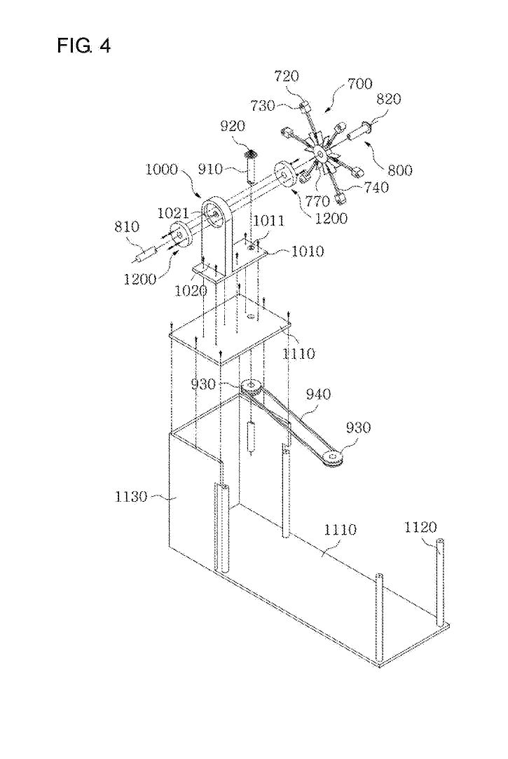

To be more specific, the blade 100 may various shapes and numbers depending on a topographical location where the wind power generator is installed and a power generating capacity and then may be coupled to the upper end of the central rotating shaft 200, as shown in FIG. 1. Preferably, the blade is formed to be curved in one of opposite rotating directions to be easily rotated by wind power.

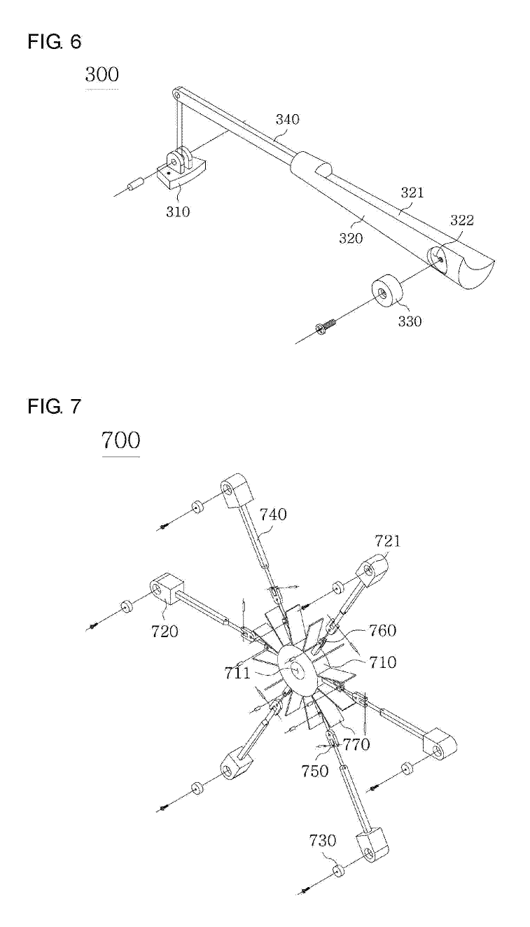

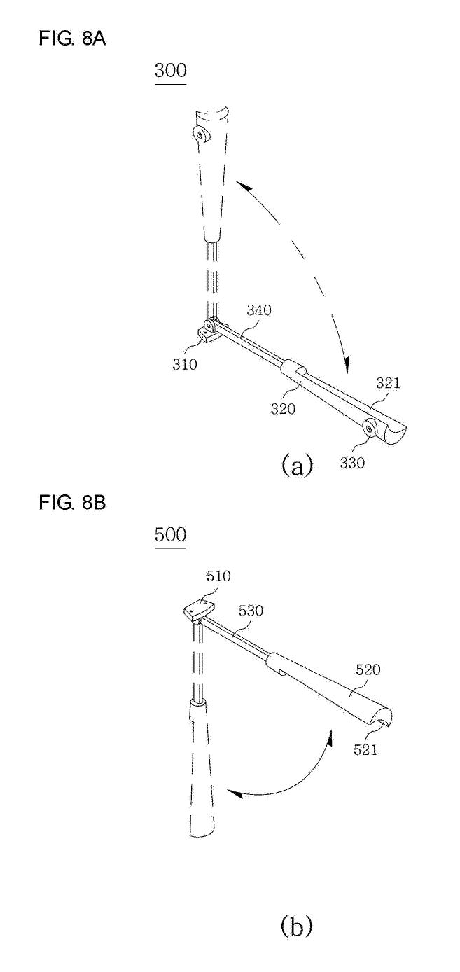

As shown in FIG. 6, the upper horizontal rotating unit 300 includes an upper shaft holder 310 that is coupled to an upper surface of the upper fastening plate 400 around the central rotating shaft 200, an upper rotating wing 320 that has on an upper surface thereof a curved downward depressed part 321 to produce ascending air current when the upper horizontal rotating unit 300 is rotated by rotation of the blade 100, a horizontal-rotating-unit magnetic member 330 that is coupled to a magnetic-member inserting hole 322 that is depressed in a side of an end of the upper rotating wing 320; and an upper rotating shaft 340 that is fastened at one side thereof to the upper shaft holder 310 by a coupling pin and is coupled at the other side thereof the upper rotating wing 320, so that the upper rotating wing 320 is opened downwards to be parallel to the horizontal frame by centrifugal force as the blade 100 rotates about the upper shaft holder 310.

The lower horizontal rotating unit 500 includes a lower shaft holder 510 that is coupled to a lower surface of the lower fastening plate 600 around the central rotating shaft 200, a lower rotating wing 520 that has on a lower surface thereof a curved upward depressed part 521 to increase rotational inertia when the lower horizontal rotating unit 500 is rotated by rotation of the blade 100, a lower rotating shaft 530 that is fastened at one side thereof to the lower shaft holder 510 by a coupling pin and is coupled at the other side thereof the lower rotating wing 520, so that the lower rotating wing is opened upwards to be parallel to the horizontal frame by centrifugal force as the blade 100 rotates about the lower shaft holder 510.

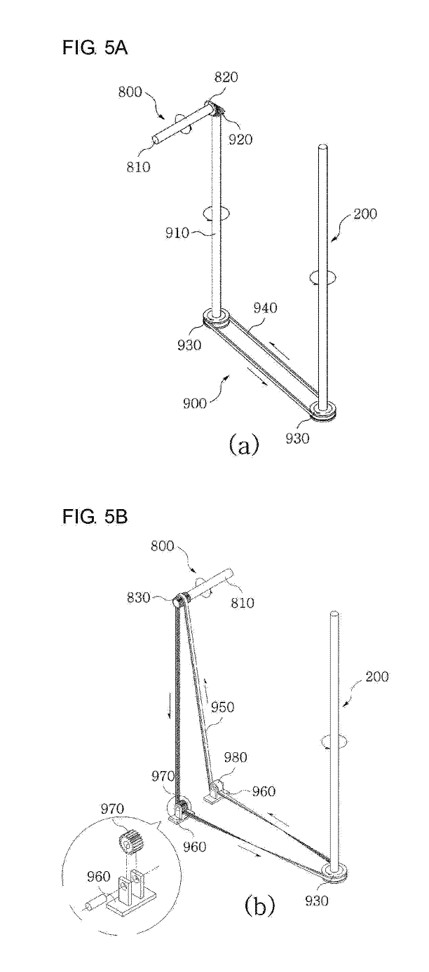

As shown in FIG. 5A, the shaft conversion unit 900 includes a belt pulley 930 that is coupled to a lower end of the central rotating shaft 200, a vertical conversion shaft 910 that is provided to pass through the side frame to be parallel to the central rotating shaft, a belt pulley that is provided on a lower end of the vertical conversion shaft to correspond to rotation of the belt pulley of the central rotating shaft, a rotary belt 940 that connects both the belt pulleys to each other and transmits rotating force of the central rotating shaft, and a shaft conversion gear 920 that is formed on an upper end of the vertical conversion shaft 910. The vertical rotating unit coupled to the horizontal rotating shaft 800 performs vertical movement in conjunction with the central rotating shaft. The horizontal rotating shaft has on an end thereof a horizontal-rotating-shaft change gear 820 to engage with the shaft conversion gear and thereby to convert horizontal rotation into vertical rotating motion, and is installed to pass through the horizontal-rotating-shaft support 1000 and.

Further, as shown in FIG. 5B, the shaft conversion unit includes a belt pulley 930 that is provided on a lower end of the central rotating shaft, a rotary gear belt 950 that is provided between the belt pulley 930 and a horizontal-rotating-shaft rotary gear to transmit rotating force of the central rotating shaft to the horizontal-rotating-shaft rotary gear 830 that is formed on an outer surface of an end of the horizontal rotating shaft passing through the horizontal-rotating-shaft support 1000, with teeth being formed on a side thereof, and a belt rotating gear 970 and a belt rotating part 980 that are rotatably coupled to two rotary-gear-belt supports 960, respectively, by a fastening pin between the belt pulley and the horizontal-rotating-shaft rotary gear to smoothly transmit rotating force of the rotary gear belt. The rotating force of the central rotating shaft transmitted by the rotary gear belt is transmitted to the horizontal rotating shaft, so that the vertical rotating unit coupled to the horizontal rotating shaft performs vertical movement in conjunction with the central rotating shaft.

The horizontal-rotating-shaft support 1000 includes a plate-shaped support plate 1010 that is fastened to an upper surface of the horizontal frame of the frame unit 1100, and has a vertical-conversion-shaft passing hole 1011 perforated on a side of an upper surface thereof such that the vertical conversion shaft 910 or the rotary gear belt of the shaft conversion unit 900 passes therethrough to transmit power, and a protruding support 1020 that protrudes upwards from an upper surface of the support plate 1010 to adjust a vertical position of the vertical rotating unit 700 and has a horizontal-rotating-shaft inserting hole 1021 that is penetrated into a center of an upper portion of the support plate to allow the horizontal rotating shaft 800 to be inserted therein. That is, the horizontal rotating shaft is rotatably inserted into the horizontal-rotating-shaft inserting hole of the protruding support to convert the horizontal rotating motion into the vertical rotating motion by the shaft conversion unit.

As shown in FIG. 7, the vertical rotating unit 700 includes a central rotating part 710 that has a horizontal-rotating-shaft passing hole 711 penetrated at a center thereof to allow the vertical rotating unit 700 to be inserted into the horizontal rotating shaft 800, at least one vertical rotating wing 720 having on a side thereof a magnetic-member coupler 721 through which a vertical-rotating-unit magnetic member 730 is coupled thereto, to continuously rotate the upper horizontal rotating unit(300 even when the blade 100 rotates at low speed due to a lack of wind power and simultaneously to double rotating speed of the upper horizontal rotating unit 300 when the blade 100 rotates at high speed, thus allowing the rotating force to be transmitted to the central rotating shaft 200; and a position adjusting shaft 740 connecting the vertical rotating wing 720 with the central rotating part such that a position of the vertical rotating wing 720 corresponds to a position of the upper rotating wing 320 provided on the upper horizontal rotating unit 300.

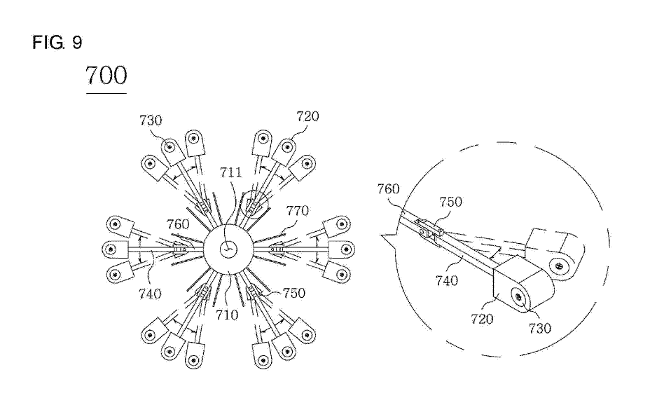

The central rotating part and the position adjusting shaft 740 are coupled with a hinge-part rotating shaft 760 formed on the central rotating part, via an “U”-shaped hinge part 750. As shown in FIG. 9, the position adjusting shaft 740 is coupled, via a fastening pin, to an “U”-shaped groove to be rotatable leftwards and rightwards, and the other side of the hinge part is coupled, via a fastening pin, to an “U”-shaped groove formed on an end of the hinge-part rotating shaft to be rotatable upwards and downwards. Therefore, the vertical rotating wing is manufactured to be movable upwards, downwards, leftwards and rightwards. Further, a foldable limiting part 770 is provided between neighboring hinge-part rotating shafts 760 to limit a moving radius of the position adjusting shaft 740. Thus, the position adjusting shaft 740 is folded within a predetermined radius by repulsive force between the vertical-rotating-unit magnetic member 730 fastened to a side of the vertical rotating wing 720 and the horizontal-rotating-unit magnetic member 330 coupled to a side of an end of the upper rotating wing 320, thus preventing the position adjusting shaft 740 or the vertical rotating wing 720 from being deformed or damaged. Preferably, when the vertical-rotating-unit magnetic member 730 is fastened to the magnetic-member coupling part 721, they are fastened to each other such that the same poles of the vertical-rotating-unit magnetic member and the horizontal-rotating-unit magnetic member 330 provided on the upper rotating wing 320 face each other.

Further, in order to allow the central rotating shaft and the horizontal rotating shaft to be smoothly rotated, bearings 1200 may be provided between the central rotating shaft, the upper fastening plate, the lower fastening plate, the frame unit and the horizontal rotating shaft and the horizontal rotation support.

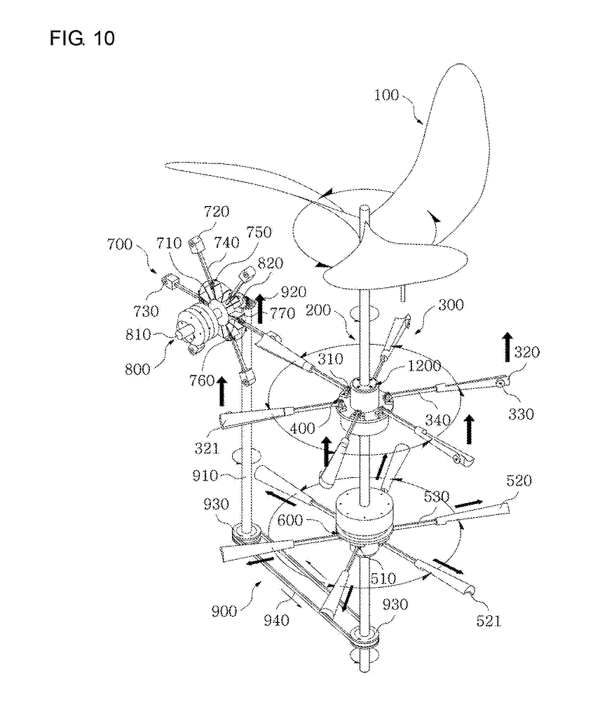

According to an embodiment, the blade 100 provided on an upper end of the apparatus for amplifying the rotating force of the wind power generator rotates in a direction by wind power, thus causing the central rotating shaft 200 to be rotated in one direction. As the central rotating shaft 200 rotates, the upper rotating wing 320 and the upper rotating shaft 340 and the lower rotating wing 520 and the lower rotating shaft 530, which are coupled to the upper surfaces of the upper fastening plate 400 and the lower fastening plate 600 around the central rotating shaft 200 by the upper shaft holder 310 and the lower shaft holder 510, may be rotatably spread downwards or upwards by centrifugal force about the upper shaft holder 310 and the lower shaft holder 510. At this time, ascending air current is produced by the downward depressed part 321 that is curvedly depressed on the upper surface of the upper rotating wing 320 that is rotatably spread downwards, as shown in FIG. 10, and then the ascending air current is transmitted to a lower portion of the blade 100, thus increasing the rotating speed of the blade 100. Meanwhile, rotational inertia is increased by the upward depressed part 521 that is curvedly depressed on the lower surface of the lower rotating wing 520 that is rotatably spread upwards, thus increasing the rotating force of the central rotating shaft 200 and enhancing power generating efficiency.

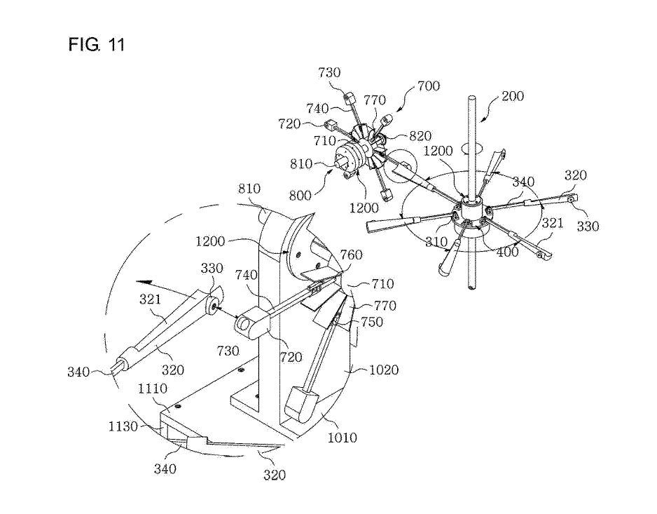

When the central rotating shaft 200 is rotated by the rotation of the blade 100, as shown in FIGS. 5A and 5B, the horizontal rotating shaft 800 and the vertical rotating unit 700 inserted into the horizontal rotating shaft 800 may also rotate in response to the rotation of the central rotating shaft 200 by the shaft conversion unit 900. In this case, as shown in the detailed view of FIG. 11, the rotating speed of the upper rotating wing 320 may be doubled by the repulsive force between the vertical-rotating-unit magnetic member 730 coupled to the vertical rotating wing 720 of the vertical rotating unit 700 and the horizontal-rotating-unit magnetic member 330 fastened to the upper rotating wing 320 of the upper horizontal rotating unit 300, which are arranged such that their same poles face each other. Even when the blade 100 rotates at low speed due to a lack of wind power acting on the blade 100, the upper rotating wing 320 may be continuously rotated by the repulsive force between the vertical-rotating-unit magnetic member 730 and the horizontal-rotating-unit magnetic member 330, thus allowing power to be continuously generated. Further, when the upper rotating wing 320 meets the vertical rotating wing 720, as shown in FIG. 9, the position adjusting shaft 740 is folded within a predetermined radius by the hinge part 750 and the hinge-part rotating shaft 760, thus preventing the vertical rotating wing 720 or the position adjusting shaft 740 from being damaged by the repulsive force between the horizontal-rotating-unit magnetic member 330 and the vertical-rotating-unit magnetic member 730. The foldable limiting part 770 protruding outwards from the outer surface of the central rotating part 710 of the vertical rotating unit 700 prevents the position adjusting shaft 740 from being excessively folded, thus preventing the repulsive force between the horizontal-rotating-unit magnetic member 330 and the vertical-rotating-unit magnetic member 730 from being reduced.

As described above, the present invention provide an apparatus for amplifying rotating force of a wind power generator, in which an upper horizontal rotating unit and a lower horizontal rotating unit that are inserted into the same rotating shaft as a blade rotatable by wind power and are provided under the blade are rotated by the rotation of the blade, so that ascending air current produced in the upper horizontal rotating unit is transmitted to the blade and thereby the rotating speed of the blade is increased and rotational inertia increased by the lower horizontal rotating unit causes the rotating force of the rotating shaft to be increased, thus allowing the wind power generator to efficiently generate power.

Further, the present invention provide an apparatus for amplifying rotating force of a wind power generator, in which magnetic members are inserted into ends of an upper horizontal rotating unit and a vertical rotating unit that is rotatable by the rotation of the upper horizontal rotating unit such that the same poles are opposite to each other, so that a blade is continuously rotated by repulsive force between the magnetic members even when the blade rotates at low speed due to a lack of wind power acting on the blade, thus enabling continuous power generation, and simultaneously the rotating speed of the blade may be doubled when the blade rotates at high speed.

While the invention has been shown and described with reference to exemplary embodiments thereof, it will be understood by those skilled in the art that various changes in form and details may be made therein without departing from the spirit and scope of the invention as defined by the appended claims.

Therefore, the scope of the invention is defined not by the detailed description of the invention but by the appended claims, and all differences within the scope will be construed as being included in the present invention.

What is claimed is:

1. An apparatus for amplifying rotating force of a wind power generator having a blade that is rotatable by wind power, the apparatus comprising:
a multilayered rack-like frame unit including layered horizontal frames, vertical frames provided between the horizontal frames to define space, and a side frame provided on a side of each horizontal frame;
a central rotating shaft rotatably provided to pass through the multilayered rack-like horizontal frames of the frame unit;
a blade coupled to an uppermost end of the central rotating shaft to cause the central rotating shaft to be rotated by wind power;
an upper fastening plate provided on an upper surface of an uppermost horizontal frame of the frame unit around the central rotating shaft; and
at least one upper horizontal rotating unit coupled to the upper fastening plate installed under the blade around the central rotating shaft, and opened downwards by centrifugal force, when the central rotating shaft is rotated by the blade.

2. The apparatus of claim 1, further comprising:
a lower fastening plate provided on a lower surface of an associated horizontal frame of the frame unit around the central rotating shaft; and
at least one lower horizontal rotating unit coupled to the lower fastening plate to be opened upwards by centrifugal force, when the central rotating shaft is rotated.

3. The apparatus of claim 1, wherein the blade is formed to be curved in one direction for unidirectional rotation.

4. The apparatus of claim 1, wherein the upper horizontal rotating unit comprises:
an upper shaft holder coupled to an upper surface of the upper fastening plate around the central rotating shaft;
an upper rotating wing having on an upper surface thereof a curved downward depressed part to produce ascending air current when the upper horizontal rotating unit is rotated by rotation of the blade;
a horizontal-rotating-unit magnetic member coupled to a magnetic-member inserting hole that is depressed in a side of an end of the upper rotating wing; and
an upper rotating shaft fastened at one side thereof to the upper shaft holder by a coupling pin, and coupled at the other side thereof the upper rotating wing, so that the upper rotating wing is opened downwards to be parallel to the horizontal frame by centrifugal force as the blade rotates about the upper shaft holder.

5. The apparatus of claim 2, wherein the lower horizontal rotating unit comprises:
a lower shaft holder coupled to a lower surface of the lower fastening plate around the central rotating shaft;
a lower rotating wing having on a lower surface thereof a curved upward depressed part to increase rotational inertia when the lower horizontal rotating unit is rotated by rotation of the blade;
a lower rotating shaft fastened at one side thereof to the lower shaft holder by a coupling pin, and coupled at the other side thereof the lower rotating wing, so that the lower rotating wing is opened upwards to be parallel to the horizontal frame by centrifugal force as the blade rotates about the lower shaft holder.

6. The apparatus of claim 1, further comprising:
a shaft conversion unit including:
a belt pulley coupled to a lower end of the central rotating shaft;
a vertical conversion shaft provided to pass through the side frame to be parallel to the central rotating shaft;
a belt pulley provided on a lower end of the vertical conversion shaft to correspond to rotation of the belt pulley of the central rotating shaft;
a rotary belt connecting both the belt pulleys to each other, and transmitting rotating force of the central rotating shaft; and
a shaft conversion gear formed on an upper end of the vertical conversion shaft; and
a vertical rotating unit including:
a horizontal rotating shaft coupled to pass through a horizontal-rotating-shaft support mounted on an upper surface of the side frame to be vertically rotated in conjunction with the central rotating shaft and thereby increase rotating force of the upper horizontal rotating unit; and
a vertical rotating wing provided on a central rotating part that is coupled to the horizontal rotating shaft via a horizontal-rotating-shaft passing hole.

7. The apparatus of claim 1, further comprising:
a shaft conversion unit including:
a belt pulley provided on a lower end of the central rotating shaft;
a rotary gear belt provided between the belt pulley and a horizontal-rotating-shaft rotary gear to transmit rotating force of the central rotating shaft to the horizontal-rotating-shaft rotary gear that is formed on an outer surface of an end of the horizontal rotating shaft passing through the horizontal-rotating-shaft support, with teeth being formed on a side thereof; and
a belt rotating gear and a belt rotating part 980 rotatably coupled to two rotary-gear-belt supports, respectively, by a fastening pin between the belt pulley and the horizontal-rotating-shaft rotary gear to smoothly transmit rotating force of the rotary gear belt; and
a vertical rotating unit including:
a horizontal rotating shaft coupled to pass through a horizontal-rotating-shaft support mounted on an upper surface of the side frame to be vertically rotated in conjunction with the central rotating shaft and thereby increase rotating force of the upper horizontal rotating unit; and
a vertical rotating wing provided on a central rotating part that is coupled to the horizontal rotating shaft via a horizontal-rotating-shaft passing hole.

8. The apparatus of claim 6, wherein the horizontal-rotating-shaft support comprises:
a plate-shaped support plate fastened to an upper surface of the horizontal frame of the frame unit, a vertical-conversion-shaft passing hole perforated on a side of an upper surface thereof such that the vertical conversion shaft or the rotary gear belt of the shaft conversion unit passes therethrough to transmit power; and
a protruding support protruding upwards from an upper surface of the support plate to adjust a vertical position of the vertical rotating unit, and having a horizontal-rotating-shaft inserting hole that is penetrated into a center of an upper portion of the support plate to allow the horizontal rotating shaft to be inserted therein.

9. The apparatus of claim 6, wherein the vertical rotating unit comprises:
a central rotating part having a horizontal-rotating-shaft passing hole penetrated at a center thereof to allow the vertical rotating unit to be inserted into the horizontal rotating shaft;
at least one vertical rotating wing having on a side thereof a magnetic-member coupler through which a vertical-rotating-unit magnetic member is coupled thereto, to continuously rotate the upper horizontal rotating unit even when the blade rotates at low speed due to a lack of wind power and simultaneously to double rotating speed of the upper horizontal rotating unit when the blade rotates at high speed, thus allowing the rotating force to be transmitted to the central rotating shaft; and
a position adjusting shaft connecting the vertical rotating wing with the central rotating part such that a position of the vertical rotating wing corresponds to a position of the upper rotating wing provided on the upper horizontal rotating unit.

10. The apparatus of claim 9, further comprising:
a hinge-part rotating shaft having an “U”-shaped end and formed on the central rotating part to be located between the central rotating part and a position adjusting shaft;
an “U”-shaped hinge part coupled with the “U”-shaped end of the hinge-part rotating shaft,
whereby the position adjusting shaft is coupled, via a fastening pin, to a groove defined in one side of the “U”-shaped hinge part to be rotatable leftwards and rightwards, and the other side of the hinge part is coupled, via a fastening pin, to an “U”-shaped groove defined in the end of the hinge-part rotating shaft to be rotatable upwards and downwards.
